(19) United States
(12) Patent Application Publication
(10) Pub. No.: US 2025/0099963 A1
(43) Pub. Date: Mar. 27, 2025

(54) RECEIVING PORT FOR TRANSFERRING OBJECTS INTO A CONTAINER AND RAPID-TRANSFER SYSTEM COMPRISING A RECEIVING PORT

(71) Applicant: ATEC PHARMATECHNIK GMBH, SOERUP (DE)

(72) Inventor: PETER HANS-LUDWIG SCHUBERT, FLENSBURG (DE)

(73) Assignee: ATEC PHARMATECHNIK GMBH, SOERUP (DE)

(21) Appl. No.: 18/832,513

(22) PCT Filed: Jan. 25, 2023
(86) PCT No.: PCT/DE2023/200020

§ 371 Date: Jul. 24, 2024

(30) Foreign Application Priority Data
Jan. 26, 2022 (DE) 10 2022 101 774.5

(51) Int. Cl. B01L 3/00

(52) U.S. Cl. CPC B01L 3/563; B01L 2200/0689; B01L 2300/0858

(57) ABSTRACT

A receiving port includes a passage opening arranged within a port contour, and a tube-like feed-through device. The passage opening includes a passage plane and a real passage cross-section, each being arranged orthogonally to a passage axis. The tube-like feed-through device is associated with the passage opening and includes a feed-through axis along which the objects are guided, and a real feed-through cross-section arranged orthogonally to the feed-through axis. The feed-through axis is arranged at an angle to the passage axis so that gravity guides the objects and so that an apparent feed-through cross-section results for the tube-like feed-through device. A passage contour and/or a feed-through contour of the real passage cross-section are formed from a respective basic contour which corresponds to the port contour of the receiving port, deformed in a shape-analogous manner to one another so that the maximized apparent feed-through cross-section is formed.

### CROSS REFERENCE TO PRIOR APPLICATIONS

This application is a U.S. National Phase application under 35 U.S.C. § 371 of International Application No. PCT/DE2023/200020, filed on Jan. 25, 2023, and which claims benefit to German Patent Application No. 10 2022 101 774.5, filed on Jan. 26, 2022. The International Application was published in German on Aug. 3, 2023 as WO 2023/143679 A1 under PCT Article 21 (2).

### FIELD

The present invention relates to a receiving port for transferring objects into a container through a passage opening which is arranged within a port contour and which has a passage axis and a passage plane arranged orthogonally to the passage axis, wherein the passage opening has a real passage cross-section arranged orthogonally to the passage axis and the passage opening is associated with a tube-like feed-through device for guiding the objects to be transferred, wherein the tube-like feed-through device has a feed-through axis along which the objects are guided and a real feed-through cross-section arranged orthogonally to the feed-through axis, and the feed-through axis is arranged at an angle to the passage axis so that the transfer of the objects to be transferred is supported by gravity by guiding the objects and an apparent feed-through cross-section results for the tube-like feed-through device in an intersection of the feed-through device with the passage plane as a function of the real passage cross-section, the angle and the real feed-through cross-section. The present invention also relates to a rapid transfer system having such a receiving port.

### BACKGROUND

Receiving ports and corresponding port systems, which are also known as “rapid transfer ports”, are in particular used to transfer objects from one side of the respective port to another side of the respective port in a sterile environment. It is also often necessary to transfer smaller objects, for example, bulk goods such as stoppers, through such a port. Corresponding ports sometimes have corresponding guide aids, such as pipe sections, on the side facing the container for this purpose, into which the corresponding small parts are filled and thus guided into the container. It is here a known problem that the corresponding feed-through cross-sections are very narrow and that small parts sometimes fall next to the port and thus become contaminated. This also compromises the sterility of the transfer.

WO 2016/046781 A1 describes a transfer system for loose objects. An arrangement is described via which loose objects can be filled into a bag through a port.

DE 10 2016 009 678 A1 describes a feedthrough with a round cross-section which is used within a transfer port to guide small parts through the transfer port.

EP 0 517 606 A2 describes a method for transferring objects from a sterile area. Specific cross-sections of a transfer aid are not described therein.

US 2003/0126799 A1 describes a coupling mechanism for port doors.

EP 3 581 339 A1 describes a tube-like transfer chute for a port system. The transfer chute there has a round cross-section and is coupled to the port so that, for example, objects can be guided through axially.

DE 10 2019 003 317 A1 describes a safety mechanism for a transfer port.

### SUMMARY

An aspect of the present invention is to improve upon the prior art.

In an embodiment, the present invention provides a receiving port for transferring objects into a container. The receiving port includes a port contour, a passage opening arranged within the port contour, and a tube-like feed-through device. The passage opening is configured so that the objects are transferred into the container via the passage opening. The passage opening comprises a passage axis, a passage plane which is arranged orthogonally to the passage axis, and a real passage cross-section which is arranged orthogonally to the passage axis. The tube-like feed-through device is associated with the passage opening. The tube-like feed-through device is configured to guide the objects to be transferred. The tube-like feed-through device comprises a feed-through axis along which the objects are guided, and a real feed-through cross-section which is arranged orthogonally to the feed-through axis. The feed-through axis is arranged at an angle to the passage axis so that the transfer of the objects to be transferred is supported by gravity guiding the objects and so that an apparent feed-through cross-section results for the tube-like feed-through device as a function of the real passage cross-section, the angle and the real feed-through cross-section in an intersection of the tube-like feed-through device with the passage plane. A passage contour of the real passage cross-section and/or a feed-through contour of the real passage cross-section are formed from a respective basic contour which corresponds to the port contour of the receiving port, deformed in a shape-analogous manner to one another so that the maximized apparent feed-through cross-section is formed.

### BRIEF DESCRIPTION OF THE DRAWINGS

The present invention is described in greater detail below on the basis of embodiments and of the drawings in which:

FIG. 1 shows a schematic representation of a receiving port in a sectional side view;

FIG. 2 shows a schematic representation of relevant components of the receiving port of FIG. 1 in a frontal view;

FIG. 3 is a schematic representation of relevant components of an alternative embodiment of a receiving port analogous to FIG. 1; and

FIG. 4 shows a schematic representation of relevant components of an alternative embodiment of the receiving port of FIG. 1 in a frontal view.

### DETAILED DESCRIPTION

The present invention provides a receiving port for transferring objects into a container through a passage opening arranged within a port contour with a passage axis and a passage plane arranged orthogonally to the passage axis, wherein the passage opening has a real passage cross-section which is arranged orthogonally to the passage axis and the passage opening is associated with a tube-like feed-through device for guiding the objects to be transferred, wherein the tube-like feed-through device has a feed-through axis, along which the objects are guided, and a real feed-through cross-section which is arranged orthogonally to the feed-through axis, and the feed-through axis is arranged at an angle to the passage axis so that the transfer of the objects to be transferred is supported by gravity by guiding the objects and an apparent feed-through cross-section is produced for the tube-like feed-through device as a function of the real passage cross-section, the angle and the real feed-through cross-section in an intersection of the feed-through device with the passage plane, wherein a passage contour of the real passage cross-section and/or a feed-through contour of the real feed-through cross-section are deformed from a respective basic contour corresponding to the port contour of the receiving port in a shape-analogous manner to one another so that a maximized apparent feed-through cross-section is formed.

By deforming the passage contour of the real passage cross-section and/or a feed-through contour of the real passage cross-section from a respective basic contour corresponding to the port contour of the receiving port in a shape-analogous manner to one another so that a maximized apparent feed-through cross-section is formed, the maximized apparent feed-through cross-section enables a better transfer of corresponding objects through the receiving port, in particular through the feed-through device. This also prevents parts from falling next to the receiving port and thus becoming contaminated due to a narrow passage, in particular a narrow passage cross-section.

In this context, it should be mentioned that, for the present invention, all terms associated with the term “passage” describe the port-side arrangement in a port plane which, for example, lies together with a passage plane or is arranged parallel to a passage plane, whereas terms here relating to “feed-through” describe the features which, analogously, are associated with the feed-through device, for example, a tube-like feed-through aid. The respective real cross-sections are in each case determined orthogonally to a longitudinal axis of the corresponding reference object, the “apparent feed-through cross-section” is measured obliquely to such axes in a corresponding intersection of the components with one another, namely, a geometric intersection as explained again below.

The following terms are here explained:

A “receiving port” refers to a connection which also known as a transfer port, for example, for sterile transfer or the transfer of, for example, nuclear-contaminated material through corresponding port parts. Corresponding “objects” are transferred, wherein these can be small parts as well as larger assemblies, for example, draw-up vials, lids or caps for sterile containers or similar components. The “transfer” refers to the physical passing of corresponding objects through the respective receiving port. The transfer takes place into a “container”, for example, into a receiving vessel, a container or an area sealed in particular in a sterile manner, wherein the transfer takes place through a “port contour”, i.e., a contour formed by the receiving port, wherein the port contour comprises a “passage opening”. A “passage axis” is arranged substantially orthogonal to the passage opening and also defines a “passage plane” substantially orthogonal to the passage axis, which passage plane is arranged in the region of the passage opening and in its plane, wherein a deviation of +15° to −15° is, for example, technically tolerable in this context with corresponding geometric relationships. Angles are here specified in relation to a full angle of 360°.

The passage opening has a “real passage cross-section”, which denotes the complete passage cross-section viewed in the orientation of the passage axis and defining the port contour. This is both the maximum and physically available cross-section of the passage opening defined along the passage axis.

A “tube-like feed-through device” is associated with the passage opening and serves to guide the objects to be transferred through the passage and is designed, for example, as a tube chute, a funnel-shaped pouring aid, or the like. The tube-like feed-through device has a “feed-through axis”, wherein this feed-through axis defines a particularly linear extension of the tube-like feed-through device. The tube-like feed-through device has a “real feed-through cross-section” which is arranged orthogonally to the feed-through axis, wherein this denotes the real cross-section of the tube-like feed-through device viewed along the feed-through axis. It should also be mentioned that the real movement and transfer of the objects takes place along the feed-through axis. The feed-through axis is arranged at an angle to the passage axis, for example, at an angle to the passage axis of the port contour so that, for example, the inclined tube-like feed-through device enables the objects to be poured, even if the port contour is arranged along a direction of gravity. The “angle” describes the real mathematical angle between the feed-through axis and the passage axis, for example, specified in degrees as parts of 360° full angles.

The passage axis is here arranged so that the objects to be transferred are transferred in a gravity-assisted manner, for example, the tube-like feed-through device is arranged in an arrangement analogous to a chute. This inclined arrangement of the tube-like feed-through device then results in an “apparent feed-through cross-section” for the tube-like feed-through device, which is the cross-section resulting from an intersection of the passage plane with the tube-like feed-through device. For example, analogous to the prior art, guiding a tube-like feed-through device with a round cross-section through a round port contour at an oblique angle would result in an oval apparent feed-through cross-section. The “intersection” here refers to the mathematical, i.e., imaginary, intersection of the corresponding geometric components with each other, for example, also applied to the physical component.

An idea of the present invention is here that corresponding contours, i.e., the passage contour of the real passage cross-section and/or a feed-through contour of the real feed-through cross-section, are “deformed”, i.e., for example, deformed from a round configuration into an oval configuration or from a slight ovality into a strong ovality or analogously in another way, so that a “maximized apparent feed-through cross-section”, i.e., an enlarged passage area in the corresponding cross-section, results. The “passage contour”, i.e., the contour of the actual receiving port, and/or a “feed-through contour”, i.e., the contour of the tube-like feed-through device, can be deformed both alternatively and in addition to each other, for example, from a round contour into an oval contour, but also in the direction of a, for example, polygonal or otherwise shaped, maximized contour in each case.

In an embodiment of the present invention, the passage contour and/or the feed-through contour can, for example, be deformed via stretching and/or compressing one or more corresponding half-axes, in particular one or more passage half-axes at least partially spanning the real passage cross-section and/or one or more feed-through half-axes at least partially spanning the feed-through cross-section from a respective basic contour corresponding to the port contour of the receiving port. The corresponding cross-sections and/or contours from a respective basic contour corresponding to the port contour of the receiving port are deformed in a shape-analogous manner to one another so that a maximized apparent feed-through cross-section is formed, i.e., the feed-through contour and thus the feed-through cross-section is maximized from a corresponding stretching and/or compression of the respective half-axes.

In the case of round or oval shapes of the corresponding geometries, for example, these half-axes relate in particular to half-axes that are orthogonal to one another, for example, a long half-axis and a short half-axis of an oval. The feed-through aid, namely, the feed-through device, can similarly, however, also have other real feed-through cross-sections. A rhombus shape, a diamond shape, a square shape or even a rectangular shape can, for example, here be selected, wherein corresponding half-axes are then determined, for example, as a connecting line between corresponding opposite side bisectors or, for example, as a diagonal of corresponding geometries. An idea of the present invention is to distort, along one or more axes, a corresponding contour in a shape-analogous manner to a corresponding contour of the component to be brought into intersection, for example, to stretch and/or compress it so that the corresponding geometry for the passage of objects is maximized, in particular in the passage plane, as an apparent feed-through cross-section in the intersection area and thus the objects are transferred correspondingly easily.

By designing the feed-through device as a tube, as a tube portion and/or as a partial tube with a partial tube wall formed on a partial circumference, a component that is easy to design can be used as a feed-through device.

A “tube” in this case is a hollow body which his completely surrounded by an outer wall with at least two opposing openings through which corresponding objects can be passed or guided.

A “tube portion” here refers to a shorter degree of formation along the longitudinal axis, i.e., the feed-through axis, wherein a “partial tube”, for example, lacks part of the wall, namely, the tube wall, along a circumference and thus only has a remaining “partial tube wall” around the circumference, at least in portions.

In an embodiment of the present invention, a feed-through collar can, for example, be associated with the feed-through opening, wherein the feed-through collar at least partially surrounds the feed-through device and supports and/or facilitates filling of the objects into the feed-through device, wherein the feed-through collar in particular at least partially and/or completely closes a gap between the port contour and the passage opening so that the objects can be reliably introduced into the feed-through device.

A feed-through collar associated with the passage opening can also support and/or facilitate the insertion of corresponding objects, wherein the feed-through collar is in particular designed so that a gap between the port contour and the passage opening is at least partially and/or completely closed. This means that the objects can be reliably inserted into the feed-through device and can no longer fall past the feed-through device purely mechanically.

A “feed-through collar” is, for example, a funnel-like collar which is at least partially connected directly to the passage opening and thus facilitates or supports the filling of the corresponding objects. The feed-through collar in particular bridges a gap between the port contour and the passage opening which results, for example, from different radii and technical boundary conditions, so that the feed-through collar in particular bridges the sterility of a transition region, which is also known as a so-called “ring of concern”.

The feed-through device and/or the feed-through collar is or are in particular received in the receiving port and/or on the passage opening movably at a joint, in particular pivotably at a pivot joint, so that the joint, in particular the pivot joint, enables the feed-through device and/or the feed-through collar to be moved, in particular pivoted, between a rest position and a use position.

A rotatably and/or pivotably arranged feed-through device and/or a correspondingly arranged feed-through collar facilitates the release of the receiving port, particularly on the container side, so that a port cover can, for example, be applied and closed.

A “joint” in this case is a movably arranged technical device that is firmly connected to itself, in particular in at least one or two degrees of freedom, which enables the feed-through device and/or the feed-through collar to be moved, in particular pivoted, for example, in the form of a pivot movement in the case of a “pivot joint”. This allows the feed-through device and/or the feed-through collar to be moved between a “rest position”, i.e., a position for, for example, trouble-free closure of the receiving port, and a “use position”, i.e., a position in which the receiving port is protected by the feed-through device and/or the feed-through collar.

A motorized drive device can here be used to operate the feed-through device and/or the feed-through collar by motor from the outside of the receiving port.

A connection of a filling bag, a filling funnel and/or a filling container, in particular on an outer side of the receiving port arranged outside the container, can be used to carry out a sterile transfer of corresponding objects from the corresponding bag or the corresponding funnel or the corresponding container.

The port contour, the real passage contour and/or the real feed-through contour is in particular round, partially oval and/or oval. This results in a partially oval, oval and/or round apparent feed-through cross-section in the intersection of the feed-through device with the passage plane, wherein, the real passage contour of the partially oval and/or oval real passage cross-section and/or the feed-through contour of the partially oval and/or oval real feed- through cross-section is in particular formed by stretching and/or compressing one or more passage half-axes that span the partially oval and/or oval passage cross-section and/or one or more feed-through half-axes that span the partially oval and/or oval passage cross-section from a respective basic contour corresponding to the port contour of the receiving port, in particular a round or substantially round basic contour, deformed in a shape-analogous manner to one another, so that a maximized apparent feed-through cross-section is formed. Corresponding round, partially oval and/or oval components of the receiving port or a corresponding port system can be manufactured and formed simply, for example, as tube parts, so that the receiving port can be constructed correspondingly simply. Square, rectangular or other geometries can alternatively also be used if the idea of maximizing the apparent feed-through cross-section according to the present invention is achieved by distorting the real cross-sections accordingly.

According to an embodiment of the present invention, if the receiving port is equipped with a port cover at the passage, the corresponding receiving port can be closed, wherein a bayonet closure in particular serves to bring about a secured and/or sealed state.

The present invention also provides a rapid transfer system with a receiving port according to one of the above embodiments.

A corresponding rapid transfer system utilizes all the advantages of the corresponding receiving port, for example, to enable a sterile transfer of objects via the corresponding rapid transfer system in a, for example, sterile environment.

The present invention is explained in greater detail with reference to exemplary embodiments as shown in the drawings.

A receiving port 101 has an annular main body 103. The annular main body 103 forms a port ring 105, which in the shown example forms a round port cross-section 193 with a port contour 194. Inside the main body 103, the port cross-section 193 is narrowed by a cover 107 and by an insertion aid 109. The insertion aid 109 is here funnel-shaped so that it is easier to insert small objects, for example, stoppers to be sterilized, into the receiving port 101.

The receiving port 101 serves to close off a sterile area on a container side 173 from an outer area on a filling side 171 of the receiving port 101.

A pipe section 121 is arranged on the container side 173 at the receiving port 101 and serves as a feed-through aid for the objects to be filled in on the container side 173. The pipe section 121 is arranged so that a feed-through axis 185, which describes the longitudinal axis of the pipe section 121, is approximately at an angle 197 of 45° to a passage axis 183, wherein the passage axis 183 runs along a longitudinal axis of the main body 103 and thus of the port ring 105. This means that the pipe section 121 is arranged at an angle of approximately 45° to the main body 103 of the receiving port 101.

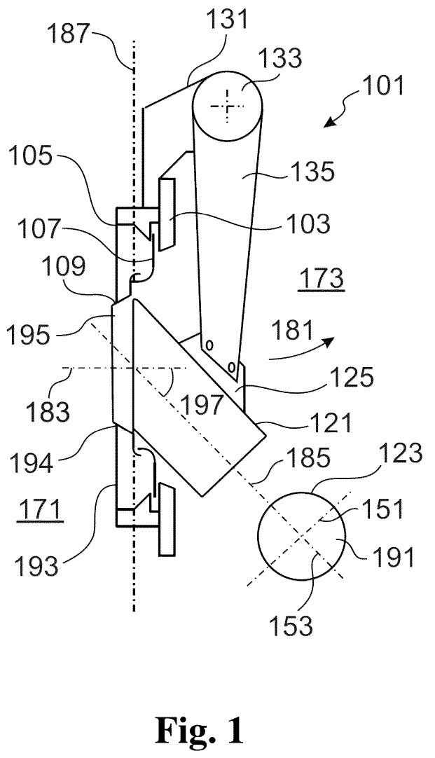

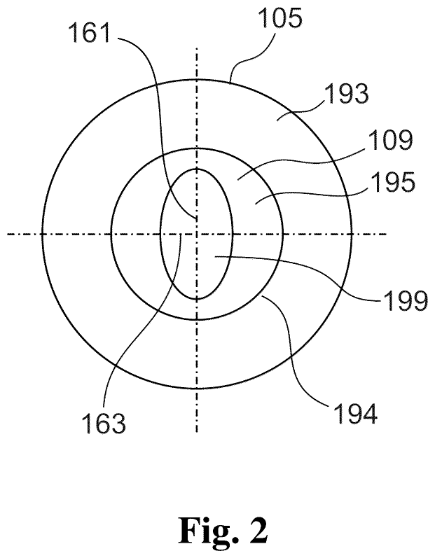

The pipe section 121 is cut in a passage plane 187, which is arranged within the main body 103 and thus within the port ring 105 orthogonally to the passage axis 183, so that an apparent feed-through passage cross-section 199 is formed. The apparent feed-through passage cross-section 199 is thus within the passage plane 187 and is formed by an intersection between the port ring 105 arranged in the passage plane 187 and a feed-through cross-section 191 of the pipe section 121. In the example of FIGS. 1 and 2, the actual port ring 105 and also the feed-through cross-section 191 of the pipe section 121 are round, so that the apparent feed-through passage cross-section 199 is oval.

The feed-through cross-section 191 of the pipe section 121 has a contour 123, which is defined by a half-axis 151 and a half-axis 153. The half-axes 151 and 153 are the same size in the example shown of a round contour 123, but can also assume different ratios to one another, depending on which contour is selected for the pipe section 121. Similarly, corresponding half-axes 161 and 163 are present on the apparent feed-through passage cross-section 199 and are correspondingly distorted in relation to the half-axes 151 and 153.

Due to the geometric arrangement and the corresponding selection of the cut in the passage plane 187 and the resulting apparent feed-through passage cross-section 199, the apparent feed-through passage cross-section 199 is so large that a corresponding quantity of stoppers to be sterilized can be easily filled in. The insertion aid 109 closes the passage cross-section 195 and narrows it to approximately the apparent feed-through passage cross-section 199, so that the cover 107 and the insertion aid 109 effectively prevent objects to be filled in from falling through into the receiving port 101.

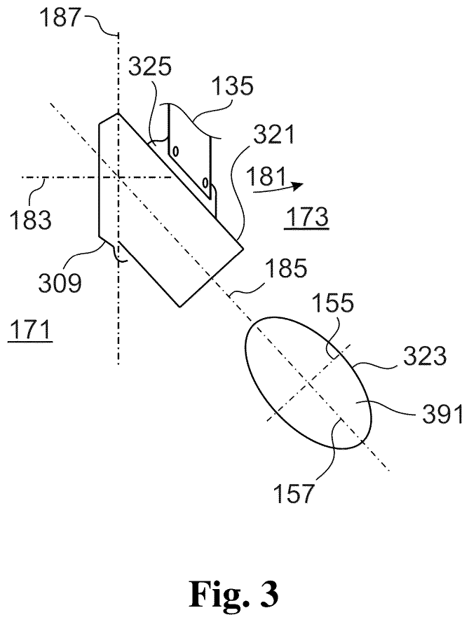

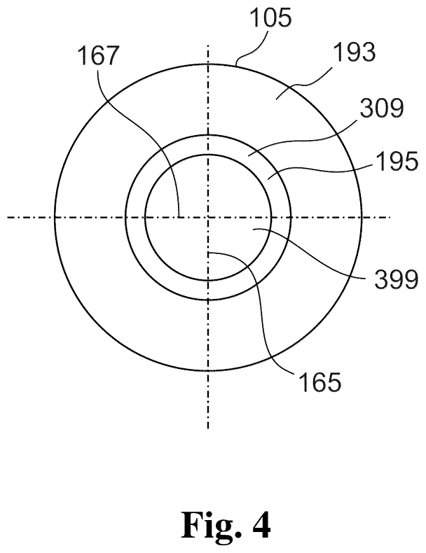

A further example of the design of a corresponding pipe section 321 is similarly described (see FIGS. 3 and 4), wherein in particular only the relevant modified components are shown in FIG. 3. Other components are designed analogously to FIG. 1 and are not shown merely for reasons of clarity.

In the example shown, the pipe section 321 is formed with a contour 323 so that an oval feed-through cross-section 391 with corresponding half-axes 155 and 157 is formed. An apparent feed-through cross-section 399 is correspondingly formed as a round cross-section with half-axes 165 and 167, wherein a modified insertion aid 309 is used to adapt the passage cross-section 195 to the apparent feed-through cross-section 399.

On the filling side 171, bulk materials can be filled in directly at the insertion aid 109 or also at the insertion aid 309 or, for example, bags with a sterile interior can be connected and then bulk materials can be transferred directly and with a sterile connection from the corresponding bag.

For both embodiments, a holder 131 is furthermore arranged on the main body 103 on the container side 173 and carries a joint 133. A swivel arm 135 is arranged on the joint 133 and carries the pipe section 121 on a connection 125 or alternatively carries the pipe section 321 on a holder 325 and can swivel both back and forth along a swiveling movement 181 of the main body 103 of the receiving port. For this purpose, the joint 133 has a motorized drive (not shown) so that the corresponding pivoting movement can be carried out from the filling side 171, for example, from an operator station.

As an alternative to the exemplary round or oval feed-through cross-sections 191 and 391 shown, alternative feed-through cross-sections can also be selected, for example, in the form of a rhombus, a diamond or even a square and/or a rectangle, wherein corresponding half-axes are then formed, for example, by opposite side bisectors or as diagonals of the corresponding areas.

The present invention is not limited to embodiments described herein; reference should be had to the appended claims.

### LIST OF REFERENCE NUMERALS

101 receiving port

103 main body

105 port ring

107 cover

109 insertion aid

121 pipe section

123 contour

125 connection

131 holder

133 joint

135 swivel arm

151 half-axis

153 half-axis

155 half-axis

157 half-axis

161 half-axis

163 half-axis

165 half-axis

167 half-axis

171 filling side

173 container side

181 swiveling movement

183 passage axis

185 feed-through axis

187 passage plane

191 feed-through cross-section

193 port cross-section

194 port contour

195 passage cross-section

197 angle

199 apparent feed-through passage cross-section

309 insertion aid

321 pipe section

323 contour

325 holder

391 oval feed-through cross-section

399 apparent feed-through cross-section

What is claimed is:

1-10. (canceled)

11. A receiving port for transferring objects into a container, the receiving port comprising:
a port contour;
a passage opening arranged within the port contour, the passage opening being configured so that the objects are transferred into the container via the passage opening, the passage opening comprising,
a passage axis,
a passage plane which is arranged orthogonally to the passage axis, and
a real passage cross-section which is arranged orthogonally to the passage axis; and
a tube-like feed-through device which is associated with the passage opening, the tube-like feed-through device being configured to guide the objects to be transferred, the tube-like feed-through device comprising,
a feed-through axis along which the objects are guided, and
a real feed-through cross-section which is arranged orthogonally to the feed-through axis,
wherein,
the feed-through axis is arranged at an angle to the passage axis so that the transfer of the objects to be transferred is supported by gravity by guiding the objects and so that an apparent feed-through cross-section results for the tube-like feed-through device as a function of the real passage cross-section, the angle and the real feed-through cross-section in an intersection of the tube-like feed-through device with the passage plane, and
a passage contour of the real passage cross-section and/or a feed-through contour of the real passage cross-section are formed from a respective basic contour which corresponds to the port contour of the receiving port, deformed in a shape-analogous manner to one another so that the maximized apparent feed-through cross-section is formed.

12. The receiving port as recited in claim 11, wherein the passage contour of the real passage cross-section and/or the feed-through contour of the real feed-through cross-section is/are deformed by stretching and/or by compressing one or more passage half-axes at least partially spanning the real passage cross-section and/or one or more feed-through half-axes at least partially spanning the real feed-through cross-section, from a respective basic contour corresponding to the passage contour of the receiving port in a shape-analogous manner to one another so that a maximized apparent feed-through cross-section is formed.

13. The receiving port as recited in claim 11, wherein the tube-like feed-through device is formed as a tube, as a tube section and/or as a partial tube with a partial tube wall formed on a partial circumference.

14. The receiving port as recited in claim 11, further comprising:
a feed-through collar which is associated with the passage opening,
wherein,
the feed-through collar at least partially surrounds the tube-like feed-through device and supports and/or facilitates an insertion of the objects into the feed-through device,

15. The receiving port as recited in claim 14, wherein the feed-through collar at least partially and/or completely closes an intermediate space between the port contour and the passage opening so that the objects are reliably introducible into the tube-like feed-through device.

16. The receiving port as recited in claim 11, further comprising:
a joint,
wherein,
the tube-like feed-through device and/or the feed-through collar is or are received movably at the joint at the receiving port and/or at the passage opening so that, via the joint, it is possible to move the tube-like feed-through device and/or the feed-through collar between a rest position and a use position.

17. The receiving port as recited in claim 11, wherein,
the joint is a pivot joint, and
the tube-like feed-through device and/or the feed-through collar is or are received movably at the pivot joint at the receiving port and/or at the passage opening so that, via the pivot joint, it is possible to pivot the tube-like feed-through device and/or the feed-through collar between the rest position and the use position.

18. The receiving port as recited in claim 17, wherein the tube-like feed-through device and/or the feed-through collar comprises a drive device which is configured to be operable from an outer side of the receiving port arranged outside of the container.

19. The receiving port as recited in claim 14, wherein the drive device is a motorized drive device.

20. The receiving port as recited in claim 11, wherein the tube-like feed-through device and/or the feed-through collar are configured for a connection of a filling bag, a filling funnel and/or a filling container,

21. The receiving port as recited in claim 20, wherein the tube-like feed-through device and/or the feed-through collar is or are further configured correspondingly to the filling bag, to the filling funnel and/or to the filling container.

22. The receiving port as recited in claim 11, wherein the port contour, the real passage cross-section and/or the real feed-through cross section are round, partially oval and/or oval, so that a partially oval cross-section, an oval cross-section and/or a round apparent passage cross-section is produced in the intersection of the tube-like feed-through device with the passage plane.

23. The receiving port as recited in claim 22, wherein the real passage cross-section of the partially oval and/or oval real passage cross-section and/or the feed-through cross-section of the partially oval and/or oval real feed-through cross-section are deformed via stretching and/or compressing one or more passage half-axes spanning the partially oval and/or oval passage cross-section and/or one or more feed-through half-axes spanning the partially oval and/or oval tube-like feed-through cross-section from a respective round or substantially round basic contour corresponding to the port contour of the receiving port in a shape-analogous manner to one another so that the maximized apparent feed-through cross-section is formed.

24. The receiving port as recited in claim 11, further comprising:
a port cover which is configured to close the passage opening in a closed state, the port cover being associated with the passage opening.

25. The receiving port as recited in claim 24, wherein,
the port cover comprises a bayonet closure, and
in the closed state, the port cover is further configured to be transferred into a secured state and/or a sealed state via the bayonet closure.

26. A rapid transfer system comprising the receiving port as recited in claim 11.
